(19) United States
(12) Patent Application Publication
(10) Pub. No.: US 2007/0248812 A1
(43) Pub. Date: Oct. 25, 2007

(54) Yttrium oxide composition, method of preparing the same, and method of forming yttrium oxide layer using the same

(75) Inventors: Dai Hong Jung, Suwon-si (KR); Seog Hyun Cho, Suwon-si (KR); Tae Ho Park, Suwon-si (KR); Sergey K. Evstropiev, Suwon-si (KR); Wan Hee Lee, Suwon-si (KR); Young Soo Kim, Suwon-si (KR); Jae Seok Park, Suwon-si (KR)

Correspondence Address: BEYER WEAVER LLP, P.O. BOX 70250, OAKLAND, CA, 94612-0250, US

(73) Assignee: SAMSUNG CORNING CO., LTD.

(21) Appl. No.: 11/786,875

(22) Filed: Apr. 12, 2007

(30) Foreign Application Priority Data
Apr. 25, 2006 (KR) 10-2006-0037145

(51) Int. Cl. C04B 35/505; B05D 5/06; B05D 1/02; B32B 5/16; B32B 19/00

(52) U.S. Cl. 428/328; 501/152; 427/64; 427/421.1; 428/702

(57) ABSTRACT

There are provided an yttrium oxide composition having particle size of 25 nm or less, a method of preparing the same and a method of forming an yttrium oxide layer using the same. The yttrium oxide composition is prepared by dissolving an yttrium salt into a solvent to prepare an yttrium salt solution, and adding a basic compound to the yttrium salt solution to adjust a pH value to a range of 3.7 to 7. The yttrium oxide composition can form an yttrium oxide layer having improved properties since the composition has particle size of 25 nm or less and uniform particle distribution.

### BACKGROUND OF THE INVENTION

1. Technical Field

The present invention relates to an yttrium oxide composition, a method of preparing the same and a method of forming an yttrium oxide layer using the same and, more particularly, to an yttrium oxide composition having particle size of 25 nm or less, a method of preparing the same and a method of forming an yttrium oxide layer using the same.

2. Discussion of the Related Art

An image quality of a display largely depends on the quality of its light supplying part. In general, the quality of a light supplying part is determined by the properties such as the luminance of light generated from the light supplying part and the luminance uniformity. Recently, a surface light source device such as flat fluorescent lamp (FFL) with enhanced luminance uniformity has been developed.

The lifetime of a surface light source device is terminated as the luminance decreases gradually over time. The main reason for the decrease of the luminance of a surface light source device is the deterioration of luminance efficiency of a fluorescent layer.

Yttrium oxide (Y₂O₃) is used for a protective layer to prevent the decrease in the luminance efficiency of a fluorescent layer. Yttrium oxide is also widely used as a sintering aid of a ceramic material, a raw material of a fluorescent body, and a fluorescent layer, etc.

It is important that yttrium oxide should have fine and uniform particle size in order to serve as the sintering aid, the fluorescent layer or the protective layer, etc. Yttrium oxide with scores to hundreds nano particle size is required for a more advanced application.

Methods of preparing yttrium oxide having particle size in nano scale are generally divided into three categories, i.e., wet chemical method, vapor phase chemical synthesis and plasma processing method.

According to the plasma processing method and the vapor phase chemical synthesis, although yttrium oxide in more uniform fine powder form can be prepared, however, the methods require much energy in process. As a result, the methods are disadvantageous in producing yttrium oxide in large scale because of high costs.

Accordingly, the wet chemical method is widely used in preparing yttrium oxide because of relatively low production cost and its simple process. The wet chemical method includes precipitation method and sol-gel method, etc. In the precipitation method, yttrium oxide particles are precipitated in colloid form in a solution containing an yttrium salt to form the yttrium oxide composition. The sol-gel method employs the hydrolysis of an yttrium organic compound. The precipitation method is widely employed in technical or economical reason since it does not require expensive yttrium organic compound and has simpler process steps than the sol-gel method.

In preparing yttrium oxide by employing the precipitation method, it is required that various process conditions be controlled in order to produce fine and uniform yttrium oxide particles. In particular, the kinds of starting materials and the pH value of the yttrium oxide composition, and the order of mixing the respective starting materials serve as important factors.

Precipitation methods of producing yttrium oxide particles by precipitation in solutions containing yttrium salts are disclosed in U.S. Pat. Nos. 5,413,736 and 5,879,647.

According to the U.S. Pat. No. 5,879,647, an aqueous solution in which an aqueous yttrium inorganic salt is dissolved is mixed with urea, and then the mixed solution is subjected to thermal treatment. Urea in the mixed solution is hydrolyzed to ammonium and carbonate ion by the thermal treatment, and yttrium hydroxycarbonate in fine particles is produced by reaction between them and yttrium ion. However, the method employing urea has low yield, and is not suitable for producing yttrium oxide in industrial scale.

Accordingly, a method of preparing efficiently yttrium oxide having fine and uniform particle distribution in nano scale is still needed.

### SUMMARY OF THE INVENTION

Therefore, the present invention is directed to provide an yttrium oxide composition having fine and uniform particle size.

Another object of the present invention is to provide a method of preparing the yttrium oxide composition having fine and uniform particle size.

Still another object of the present invention is to provide a method of forming an yttrium oxide layer using the yttrium oxide composition.

An exemplary embodiment of the present invention provides an yttrium oxide composition, which comprises yttrium oxide (Y₂O₃) particles having particle size of 25 nm or less, and has a pH value of 3.7 to 7.

In accordance with an exemplary embodiment, the yttrium oxide composition may further comprise boron oxide (B₂O₃).

An exemplary embodiment of the present invention provides a method of preparing the yttrium oxide composition, which comprises dissolving an yttrium salt into a solvent to prepare an yttrium salt solution, and possibly adding a basic compound to the yttrium salt solution to possibly adjust a pH value to a range of 3.7 to 7.

In accordance with an exemplary embodiment, the yttrium salt solution has an yttrium concentration of 0.01M to 1.0M.

In accordance with an exemplary embodiment, the yttrium salt solution may comprise yttrium nitrate, yttrium acetate or yttrium chloride.

In accordance with an exemplary embodiment, the solvent may comprise water or an alcohol.

In accordance with an exemplary embodiment, the yttrium salt solution may further comprise a boron compound.

In accordance with an exemplary embodiment, the basic compound may comprise an ammonium compound.

An exemplary embodiment of the present invention provides a method of forming an yttrium oxide layer, which comprises dissolving an yttrium salt into a solvent to prepare an yttrium salt solution, adding a basic compound to the yttrium salt solution to adjust a pH value to a range of 3.7 to 7, thereby preparing an yttrium oxide composition containing yttrium oxide particles having particle size of 25 nm or less, and spray-coating a subject body with the yttrium oxide composition, thereby forming a yttrium oxide layer.

In accordance with an exemplary embodiment, the method may further comprise calcining by thermal treatment of the coated yttrium oxide layer at 490° C. to 600° C.

According to the present invention, an yttrium oxide composition having fine and uniform distribution of yttrium oxide particles can be prepared. Particularly, the particle size of yttrium oxide according to the present invention does not exceed 25 nm. Further, It is easy to form an yttrium oxide layer having an appropriate thickness by coating a subject body such as a substrate with the yttrium oxide composition since the composition has high transparency and low viscosity.

The yttrium oxide composition according to the present invention can be used as a protective layer in, for example, a fluorescent lamp for backlight or a surface light source for backlight by coating the substrate of the fluorescent lamp or the surface light source with the yttrium oxide composition. Particularly, the protective layer, which is composed of the yttrium oxide composition according to the present invention, can be employed by coating the fluorescent layer surface of a thin tube lamp or a surface light source with the yttrium oxide composition.

The yttrium oxide composition according to the present invention can be used as a protective layer for various discharging devices such as a fluorescent lamp for backlight or a plasma display panel (PDP).

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a scanning electron microscopy (SEM) photograph showing the surface of the substrate which is coated with the yttrium oxide composition according to Example 14 of the present invention;

FIG. 2 is an SEM photograph showing the surface of the substrate which is coated with the yttrium oxide composition according to Example 15 of the present invention;

FIG. 3 is an SEM photograph showing the surface of the substrate which is coated with the yttrium oxide composition according to Example 16 of the present invention;

FIG. 4 is an SEM photograph showing the surface of the substrate which is coated with the yttrium oxide composition according to Comparative example 1; and

FIG. 5 is an SEM photograph showing the surface of the substrate which is coated with the commercial yttrium oxide solution according to Comparative example 4.

### DETAILED DESCRIPTION OF THE INVENTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

An Yttrium Oxide Composition and a Preparation Method Thereof

In preparing an yttrium oxide composition according to the present invention, an yttrium salt is dissolved in a solvent to prepare an yttrium salt solution.

The concentration of the yttrium salt has a range of about 0.01M to about 1.0M. In order to increase the yield of yttrium oxide in a reaction of producing yttrium oxide, it is important to form a super-saturated solution of yttrium oxide. The concentration of the yttrium salt influences the super-saturation rate of yttrium oxide in the reaction of producing yttrium oxide. If the concentration of the yttrium salt is less than about 0.01M, much time is needed undesirably in progressing the process. However, if the concentration of the yttrium salt exceeds about 1.0M, the solution may be too quickly super-saturated, and thus it becomes difficult to control the process speed. Further, yttrium oxide particles may be aggregated, thereby producing particles densely aggregated in nonuniform size. Therefore, the concentration of the yttrium salt contained in the yttrium salt solution may be about 0.01M to about 1.0M.

The yttrium salts include soluble yttrium salts such as yttrium nitrate, yttrium acetate and yttrium chloride. Further, the solvent includes water or alcohols such as methanol, ethanol and propanol.

In accordance with an exemplary embodiment, the yttrium salt solution may further comprise boron compounds such as boron oxide. The boron compounds enhance the adhesiveness of the yttrium oxide particles to a substrate consisting of an inorganic material such as glass when forming an yttrium oxide layer by coating the yttrium oxide composition on the substrate, for example, by spraying. Further, the boron compounds serve as a buffer in an aqueous solution. Even though a little acid or basic solution is added to the solution comprising the boron compounds, the pH value of the solution maintains almost constant, and thus is not changed drastically. Thus, a phenomenon that yttrium oxide particles are aggregated by drastic change of the pH value can be prevented. If the yttrium salt solution comprises boron compounds, the process temperature must not exceed about 600° C. to prevent the production of the yttrium borate.

The pH value of the yttrium salt solution is controlled by adding a basic compound to the yttrium salt solution, thereby forming the yttrium oxide composition having a pH value in a range of about 3.7 to about 7. The basic compounds may include an ammonium compound, a boron compound, or other organic basic compound. In accordance with an exemplary embodiment, the pH value is controlled in a range of about 3.7 to about 7 by adding ammonium hydroxide to the yttrium salt solution.

The yttrium salt solution produces yttrium oxide by following reactions I and II with hydroxide ion (OH⁻):

Y₃++3OH⁻→Y(OH)₃ (I)

Y(OH)₃+Y(OH)₃→Y₂O₃+H₂O (II)

Referring to the reaction scheme 1, the yttrium ion (y³⁺) present in the yttrium salt solution produces the yttrium hydroxide (Y(OH)₃) by reaction with hydroxide ion (OH⁻) in a basic solution. Thus, according to the reaction scheme I, as the concentration of the hydroxide ion in the yttrium salt solution increases, i.e., the pH value increases, the yield of the yttrium hydroxide increases. However, if the pH value of the yttrium oxide composition is higher than about 7, the transparency of the yttrium oxide composition decreases, and the viscosity of the solution undesirably increases excessively. Further, the yttrium oxide composition having a pH value of 7 or higher may be not uniform, or may be aggregated to produce coarse particles. Accordingly, the yttrium oxide composition may have pH values in a range of about 3.7 to about 7.

Referring to the reaction scheme 11, water is removed from two yttrium hydroxide molecules through condensation reaction to produce yttrium oxide (Y₂O₃). The yttrium oxide particles are present in colloid form or sol form in the solution. When water is removed in the reaction scheme 11, rightward reaction is accelerated by chemical reaction equilibrium. A solution in which yttrium oxide is super-saturated can be formed in order to further accelerate the production of yttrium oxide. In accordance with an exemplary embodiment, removing water from the yttrium oxide composition continuously, thereby accelerating the reaction of producing yttrium oxide can further increase the saturation rate of yttrium oxide to the yttrium oxide composition.

The order of mixing the yttrium salt solution and the basic solution as well as the concentration of the yttrium salt solution, and the pH value of the yttrium oxide composition influence on producing fine particles in nano scale. In accordance with an exemplary embodiment, fine particles of yttrium oxide in small sizes can be produced by adding a basic solution to an yttrium salt solution to control pH values of the yttrium oxide composition.

Method of Forming an Yttrium Oxide Layer

First, an yttrium oxide composition is prepared by the substantially same process as described above.

In particular, an yttrium salt solution is prepared by dissolving an yttrium salt in a solvent. The concentration of the yttrium salt has a range of about 0.01M to about 1.0M. The yttrium salt may include yttrium nitrate, yttrium acetate and yttrium chloride. The solvent may include water, or an alcohol such as methanol, ethanol and propanol.

In accordance with an exemplary embodiment, the yttrium salt solution may further comprise boron compounds such as boron oxide.

The pH value of the yttrium salt solution is controlled by adding a basic compound to the yttrium salt solution, thereby forming the yttrium oxide composition having a pH value in a range of about 3.7 to about 7. The basic compounds may include an ammonium compound, a boron compound, or an organic basic compound. In accordance with an exemplary embodiment, the pH value is controlled by adding ammonium hydroxide.

After the pH value of the yttrium oxide composition is controlled, the yttrium oxide composition is stirred, and then an yttrium oxide layer or an yttrium oxide power comprising fine yttrium oxide particles can be formed by removing the liquid solvent such as water or an alcohol from the yttrium oxide composition.

In accordance with an exemplary embodiment, the yttrium oxide composition may be sprayed on a subject body such as a substrate by a spraying dry process, and the solvent may be removed to dryness, thereby obtaining an yttrium oxide layer coated on the subject body with a desired thickness. The thickness of the yttrium oxide layer can vary with various spraying conditions. Coating the yttrium oxide composition on the subject body by the spraying dry process prevents the yttrium oxide particles from being aggregated thereby being coarse. Thus, an yttrium oxide layer comprising the yttrium oxide particles having fine and uniform size distribution not exceeding about 25 nm can be prepared. The subject body can be used in preparing a fluorescent light source, and may be a glass substrate consisting of soda lime glass. The yttrium oxide layer can be formed by coating the composition on the subject body directly. Alternatively, the yttrium oxide layer can be formed on a fluorescent layer disposed on the subject body by coating the fluorescent layer with the yttrium oxide composition.

In accordance with another exemplary embodiment, an yttrium oxide layer can be formed on a substrate by depositing the substrate in the yttrium salt composition, and then drying.

In accordance with still another exemplary embodiment, yttrium oxides in powders can be obtained by spraying the yttrium oxide composition in a collection chamber.

Thus, the obtained layer or yttrium oxides in powders are subjected to a calcining process. In accordance with an exemplary embodiment, the calcining process is carried out at temperature of about 490° C. or higher, and preferably, may be carried out at about 490° C. to about 600° C. According to the process, an yttrium oxide layer consisting of yttrium oxide particles having a size of about 25 nm or less can be obtained.

Hereinafter, the properties of the yttrium oxide composition and the yttrium oxide layer are described in detail through various examples and comparative examples.

Evaluation for the Properties of the Yttrium Oxide Composition and the Layer Formed by the Composition

### EXAMPLE 1

36 g of boric acid (H₃BO₃, Sigma, Aldrich) was dissolved in 1 L of ethanol to prepare 10 ml of boric acid solution. Yttrium nitrate 6 hydrate (Y(NO₃)₃-6H₂O, Sigma, Aldrich) was dissolved in water to prepare 50 ml of 0.065M yttrium nitrate solution. The boric acid solution and the yttrium nitrate solution were mixed to prepare an yttrium salt solution. Ammonium hydroxide solution was slowly dropped into the yttrium salt solution to prepare an yttrium oxide composition, pH value of which was controlled at 4.00.

### EXAMPLES 2 to 9

Yttrium oxide compositions were prepared in the substantially same method as described in Example 1 except for the amounts of the ammonium hydroxide solution added to the yttrium salt solution. Yttrium oxide compositions of Examples 2 to 9 having pH values of 5.79, 5.90, 6.09, 6.15, 6.57, 6.65, 6.98 and 7.06 were prepared by varying the amounts of the ammonium hydroxide solution added to the yttrium salt solution.

### EXAMPLES 10 to 13

36 g of boric acid (H₃BO₃, Sigma, Aldrich) was dissolved in 1 L of ethanol to prepare 10 ml of boric acid solution. Yttrium nitrate 6 hydrate (Y(NO₃)₃-6H₂O, Sigma, Aldrich) was dissolved in water to prepare 50 ml of 0.47M yttrium nitrate solution. The boric acid solution and the yttrium nitrate solution were mixed to prepare an yttrium salt solution. Yttrium oxide compositions of Examples 10 to 13 having pH values of 5.90, 6.37, 6.50 and 6.63 were prepared by varying the amounts of the ammonium hydroxide solution added to the yttrium salt solution.

### COMPARATIVE EXAMPLE 1

36 g of boric acid (H₃BO₃, Sigma, Aldrich) was dissolved in 1 L of ethanol to prepare 10 ml of boric acid solution. Yttrium nitrate 6 hydrate (Y(NO₃)₃-6H₂O, Sigma, Aldrich) was dissolved in water to prepare 50 ml of 0.065M yttrium nitrate solution. The boric acid solution and the yttrium nitrate solution were mixed to prepare an yttrium salt solution. Ammonium hydroxide solution was slowly dropped into the yttrium salt solution to prepare an yttrium oxide solution, pH value of which was controlled at 8.62.

### COMPARATIVE EXAMPLE 2

An yttrium oxide composition was prepared in the substantially same method as described in Comparative example 1 except for the amount of the ammonium hydroxide added to the yttrium salt solution. An yttrium oxide composition having pH value of 8.06 was prepared by varying the amount of the ammonium hydroxide solution added to the yttrium salt solution.

### COMPARATIVE EXAMPLE 3

36 g of boric acid (H₃BO₃, Sigma, Aldrich) was dissolved in 1 L of ethanol to prepare 10 ml of boric acid solution. Yttrium nitrate 6 hydrate (Y(NO₃)₃-6H₂O, Sigma, Aldrich) was dissolved in water to prepare 50 ml of 0.47M yttrium nitrate solution. The boric acid solution and the yttrium nitrate solution were mixed to prepare an yttrium salt solution. Ammonium hydroxide solution was slowly dropped into the yttrium salt solution to prepare a solution, pH value of which was controlled up to 8.89. The constitution and pH values of the yttrium oxide compositions according to Examples 1 to 13 and Comparative examples 1 to 3 are shown in table 1 below.

TABLE 1

| | Concentration of yttrium | |
|---|---|---|
| | salt solution (M) | pH |
| Example 1 | 0.065 | 4.00 |
| Example 2 | 0.065 | 5.79 |
| Example 3 | 0.065 | 5.90 |
| Example 4 | 0.065 | 6.09 |
| Example 5 | 0.065 | 6.15 |
| Example 6 | 0.065 | 6.57 |
| Example 7 | 0.065 | 6.65 |
| Example 8 | 0.065 | 6.98 |
| Example 9 | 0.065 | 7.06 |
| Example 10 | 0.47 | 5.90 |
| Example 11 | 0.47 | 6.37 |
| Example 12 | 0.47 | 6.50 |
| Example 13 | 0.47 | 6.63 |
| Comparative example 1 | 0.065 | 8.62 |
| Comparative example 2 | 0.065 | 8.06 |
| Comparative example 3 | 0.47 | 8.89 |

Further, the color and viscosity of the yttrium oxide compositions according to Examples 1 to 13 and Comparative examples 1 to 3 are shown in table 2 below.

TABLE 2

| | Color | Viscosity |
|---|---|---|
| Example 1 | transparent | low viscosity |
| Example 2 | transparent | low viscosity |
| Example 3 | slightly opalescent | low viscosity |
| Example 4 | slightly opalescent | slightly increased viscosity |
| Example 5 | slightly opalescent | slightly increased viscosity |
| Example 6 | opalescent | increased viscosity |
| Example 7 | transparent | low viscosity |
| Example 8 | slightly opalescent | low viscosity |
| Example 9 | opalescent | increased viscosity |
| Example 10 | transparent | low viscosity |
| Example 11 | transparent | slightly increased viscosity |
| Example 12 | opalescent | increased viscosity, slightly non- |
| | | uniform |
| Example 13 | opalescent | increased viscosity, slightly non- |
| | | uniform |
| Comparative | turbid | high viscosity |
| example 1 | | |
| Comparative | turbid | high viscosity |
| example 2 | | |
| Comparative | turbid | high viscosity, non-uniform |
| example 3 | | |

Referring to tables 1 and 2, it can be found that the pH values of the compositions have important effects on the properties such as color and viscosity of the yttrium oxide compositions.

When comparing Examples 1 to 9 having the same yttrium salt concentration of 0.065M, as the pH values increase, the transparency of yttrium oxide compositions decreases and their viscosity increases. When also comparing Examples 10 to 13 having the same yttrium salt concentration of 0.47M, as the pH values increase, the transparency of yttrium oxide compositions decreases and their viscosity increases. In particular, when the pH value exceeds 8, the transparency of the yttrium oxide composition is greatly deteriorated and its viscosity increases, and thus the composition shows unsuitable properties for a coating composition.

In comparison with the compositions of Comparative examples 1 to 3 showing the deteriorated transparency and high viscosity, the compositions of Examples 1 to 13 showed comparatively low viscosity and better transparency.

The yttrium oxide compositions of Examples 1 to 13 and Comparative examples 1 to 3 were spray-coated onto the surfaces of the respective substrates composed of soda lime glasses. The substrates, on which the respective yttrium oxide compositions were coated, were dried, and then calcined for about 45 minutes at about 500° C. to cure the coated yttrium oxide composition, thereby forming yttrium oxide layers.

After the calcining process, the components constituting the cured yttrium oxide layer were analyzed by X-ray diffraction analysis (XRD). As a result of the X-ray diffraction analysis, the yttrium oxide layers prepared according to Examples 1 to 5 were composed of 35.09 mol % of yttrium oxides (Y₂O₃) and 64.91 mol % of boron oxides (B₂O₃). Further, the yttrium oxide layers prepared according to Examples 6 to 13 and Comparative examples 1 to 3 were composed of only yttrium oxides.

Evaluation for Luminance of Yttrium Oxide Layers

In order to evaluate the luminance of the yttrium oxide layers formed by employing the yttrium oxide compositions according to the present invention, the yttrium oxide compositions according to Examples 3 and 12 were prepared. Further, in order to compare with the yttrium oxide layers, the yttrium oxide solution of Comparative example 4, that is, a commercial yttrium oxide solution in suspension comprising about 5% by weight of yttrium oxide having average particle size of about 50 nm, was prepared.

The yttrium oxide compositions according to Examples 3 and 12, and Comparative example 4 were spray-coated onto the surfaces of substrates made of glass. The glass substrates had composite fluorescent layers consisting of three different phosphor particles. The substrates coated with the solutions were dried, and then calcined for about 10 minutes at about 650° C. to cure. After calcining, the chemical constitution of the cured yttrium oxide is layers was analyzed by X-ray diffraction analysis. As a result, the yttrium oxide layer prepared according to Example 3 was composed of 35.09 mol % of yttrium oxides (Y₂O₃) and 64.91 mol % of boron oxides (B₂O₃), and the yttrium oxide layers prepared according to Example 12 and Comparative example 4 were composed of only yttrium oxides.

The substrate not coated with yttrium oxide, and the substrate coated with the yttrium oxide compositions according to Examples 3 and 12, and Comparative example 4 were measured for their luminance, and the reflectance and transmittance of light. Luminance was measured by employing a luminance calorimeter (Htopcon BM-7), and the spectra of light reflection and light transmittance were measured by employing a scanning spectrophotometer (Shimadzu UV-2101PC). The results are shown in table 3 below.

TABLE 3

| | |
|---|---|
| Luminance | Color |
| (cd/m²) | coordinates |

| | | | |
|---|---|---|---|
| Without coating | 41.40 | 0.3285 | 0.2648 |
| Example 3 | 36.46 | 0.3166 | 0.2769 |
| Example 12 | 33.98 | 0.3152 | 0.3673 |
| Comparative example 4 | 29.50 | 0.3255 | 0.2181 |

Referring to the table 3, the luminance of all the substrates, which were coated with yttrium oxide compositions, was decreased compared to that of the substrate comprising only composite fluorescent layer without coating the yttrium oxide composition. However, the luminance of the substrates, which were coated with the yttrium oxide compositions according to Examples 3 and 12 of the present invention, was slightly decreased compared to that of the substrate which was coated with the commercial yttrium oxide solution according to Comparative example 4.

Evaluation for the Particle Size and Distribution of the Yttrium Oxide Layer

### EXAMPLE 14

0.67 g of boric acid (H₃BO₃, Sigma, Aldrich) was dissolved in 10 ml of ethanol to prepare a boric acid solution. 0.1 g of Yttrium acetate (Y(CH₃COO)₃, Sigma, Aldrich) was dissolved in 5 ml of water to prepare 0.075M yttrium acetate solution.

The boric acid solution and the yttrium acetate solution were mixed to form yttrium oxide composition in a slightly opalescent colloid sol state. The yttrium oxide composition in the sol state was stirred for about 30 minutes, and then sprayed on a substrate consisting of soda lime glass at ambient temperature.

The substrate, which is coated with the yttrium oxide composition, was calcined for about 45 minutes at about 500° C. As a result, an yttrium oxide layer was formed on the substrate.

### EXAMPLE 15

17 g of yttrium nitrate 6 hydrate (Y(NO₃)₃-6H₂O, Sigma, Aldrich) was dissolved in 45 ml of water to prepare 0.98M yttrium salt solution. Ammonium hydroxide solution was slowly dropped into the yttrium salt solution to prepare an yttrium oxide composition, pH value of which was controlled at 5.87. The glass substrates had composite fluorescent layers consisting of three different phosphor particles having average particle size of about 3 μm to about 5 μm. The yttrium oxide composition was stirred for about 30 minutes, and then sprayed on a substrate at ambient temperature.

The substrate, which is coated with the yttrium oxide composition, was dried and calcined for about 45 minutes at about 560° C. As a result, an yttrium oxide layer was formed on the substrate.

### EXAMPLE 16

51 g of yttrium nitrate 6 hydrate (Y(NO₃)₃-6H₂O, Sigma, Aldrich) was dissolved in a mixed solution of 50 ml of water, 90 ml of ethanol, 5 ml of 2-propanol and 5 ml of methanol to prepare 0.89M yttrium salt solution. Ammonium hydroxide solution was slowly dropped into the yttrium salt solution to prepare an yttrium oxide composition, pH value of which was controlled at 3.70. The glass substrates had composite fluorescent layers consisting of three different phosphor particles having average particle size of about 3 μm to about 5 μm. The yttrium oxide composition was stirred for about 30 minutes, and then sprayed on a substrate at ambient temperature.

The substrate, which is coated with the yttrium oxide composition, was dried and calcined for about 45 minutes at about 560° C. As a result, an yttrium oxide layer was formed on the substrate.

The thickness of the yttrium oxide layer was about 300 nm to about 320 nm. As a result of the X-ray diffraction analysis for the chemical constitution of the yttrium oxide layer, the yttrium oxide layer was composed of 96.84 mol % of amorphous boron oxides (B₂O₃) and 3.16 mol % of crystalline yttrium oxides (Y₂O₃).

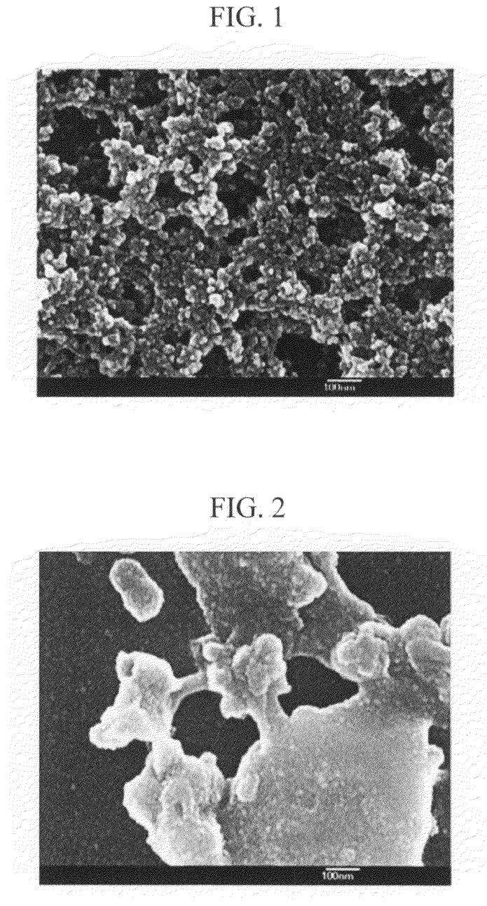

FIG. 1 is a photograph illustrating the surface of the substrate which is coated with the yttrium oxide composition according to Example 14, using scanning electron microscopy (SEM, JEOL JSM 6500) at 100,000-fold magnification. In FIG. 1, the bar disposed low relative to FIG. 1 shows a length of 100 nm.

Referring to FIG. 1, it is shown that the substrate surface is coated with spherical yttrium oxide particles having a size range of about 10 nm to about 15 nm in uniform distribution. The maximum particle size does not exceed about 25 nm, and aggregated coarse particles are not present.

FIG. 2 is a photograph illustrating the surface of the substrate which is coated with the yttrium oxide composition according to Example 15, using scanning electron microscopy at 100,000-fold magnification. In FIG. 2, the bar disposed low relative to FIG. 2 shows a length of 100 nm.

Referring to FIG. 2, it is shown that spherical yttrium oxide particles having a size range of about 15 nm to about 20 nm are slightly aggregated, but the substrate surface is coated with the spherical yttrium oxide particles in generally uniform distribution.

FIG. 3 is a photograph illustrating the surface of the substrate which is coated with the yttrium oxide composition according to Example 16, using scanning electron microscopy at 100,000-fold magnification. In FIG. 3, the bar disposed low relative to FIG. 3 shows a length of 100 nm.

Referring to FIG. 3, it is shown that the substrate surface is coated with spherical yttrium oxide particles having a size range of about 7 nm to about 10 nm in uniform distribution. The aggregated coarse particles are not present.

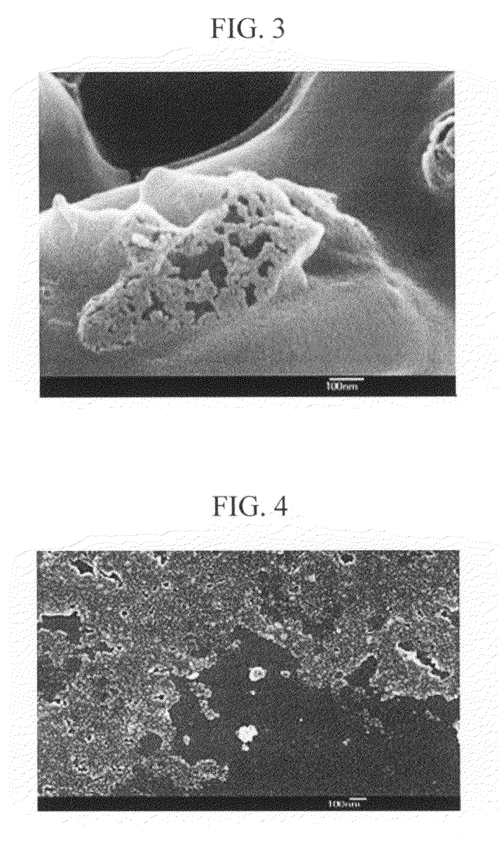

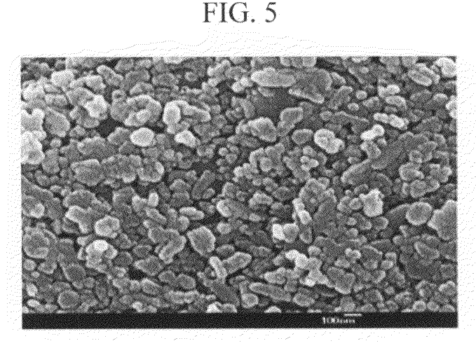

FIG. 4 is a photograph illustrating the surface of the substrate which is coated with the yttrium oxide composition according to Comparative example 1, using scanning electron microscopy at 50,000-fold magnification. In FIG. 4, the bar disposed low relative to FIG. 4 shows a length of 100 nm.

Referring to FIG. 4, it is shown that the substrate surface is coated with comparatively fine spherical yttrium oxide particles. However, it was shown that the distribution of the particles is comparatively non-uniform, and the aggregated coarse particles having a size of 100 nm higher are present.

FIG. 5 is a photograph illustrating the surface of the substrate which is coated with the commercial yttrium oxide solution according to Comparative example 4, using scanning electron microscopy at 50,000-fold magnification. In FIG. 5, the bar disposed low relative to FIG. 5 shows a length of 100 nm.

Referring to FIG. 5, it is shown that the size of the yttrium oxide particle is about 50 nm on average, and particles having a size of 100 nm or higher are also present in significant numbers.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents.

What is claimed is:

1. An yttrium oxide composition comprising yttrium oxide particles having particle size of 25 nm or less, wherein the composition has a pH value in a range of 3.7 to 7.

2. The yttrium oxide composition according to claim 1, wherein the composition further comprises boron oxide.

3. A method of preparing an yttrium oxide composition, wherein the method comprises dissolving an yttrium salt into a solvent to prepare an yttrium salt solution; and adding a basic compound to the yttrium salt solution to adjust a pH value to a range of 3.7 to 7, thereby forming an yttrium oxide composition having yttrium oxide particle size of 25 nm or less.

4. The method according to claim 3, wherein the yttrium salt solution has a concentration of 0.01M to 1.0M.

5. The method according to claim 3, wherein the yttrium salt comprises at least one material selected from the group consisting of yttrium nitrate, yttrium acetate and yttrium chloride.

6. The method according to claim 3, wherein the solvent comprises water or an alcohol.

7. The method according to claim 3, wherein the yttrium salt solution further comprises a boron compound.

8. The method according to claim 3, wherein the basic compound comprises an ammonium compound.

9. A method of forming an yttrium oxide layer comprising:
dissolving an yttrium salt into a solvent to prepare an yttrium salt solution;
adding a basic compound to the yttrium salt solution to adjust a pH value to a range of 3.7 to 7, thereby forming an yttrium oxide composition containing yttrium oxide particles having particle size of 25 nm or less; and
spray-coating a subject body with the yttrium oxide composition, thereby forming a yttrium oxide layer.

10. The method according to claim 9, further comprising calcining by thermal treatment of the coated yttrium oxide layer at 490° C. to 600° C.

11. The method according to claim 9, wherein the subject body is a glass substrate or a fluorescent layer formed on the glass substrate.

12. A substrate for a surface light source comprising a coating layer formed on the substrate, and formed from an yttrium oxide composition comprising yttrium oxide particles having particle size of 25 nm or less, wherein the composition has a pH value in a range of 3.7 to 7.

13. The substrate according to claim 12, wherein the coating layer is formed on the surface of a fluorescent layer formed on the substrate surface

14. A discharging device comprising a coating layer formed on a substrate and formed from an yttrium oxide composition comprising yttrium oxide particles having particle size of 25 nm or less, wherein the composition has a pH value in a range of 3.7 to 7.

15. The discharging device according to claim 14, wherein the discharging device is a fluorescent lamp for backlight or a plasma display panel (PDP).
